(19) United States
(12) Patent Application Publication
(10) Pub. No.: US 2008/0153419 A1
(43) Pub. Date: Jun. 26, 2008

(54) METHOD AND APPARATUS FOR ERROR RECOVERY IN COGINITIVE RADIO SYSTEMS

(75) Inventors: Nicholas E. Buris, Deer Park, IL (US); Lawrence M. Ecklund, Wheaton, IL (US); Louis J. Vannatta, Crystal Lake, IL (US); Alvin J. Von Ruff, Gibson City, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/614,230

(22) Filed: Dec. 21, 2006

(51) Int. Cl. H04B 7/24

(52) U.S. Cl. 455/62

(57) ABSTRACT

A method and apparatus for recovering from cognitive radio errors are disclosed. The method may include receiving stamp data relating to a cognitive radio from the cognitive radio's database, the stamp data including time, location and sensor information, comparing the received stamp data with information stored in a master database, determining, based on the comparison, whether the cognitive radio's database is corrupt, wherein if the cognitive radio's database is corrupt, downloading a copy of the master database to the cognitive radio.

### BACKGROUND OF THE INVENTION

1. Field of the Invention

The present invention relates to the field of cognitive radio communications.

2. Introduction

A cognitive radio is a radio that is described by a number of attributes. One of those attributes is its capability of getting data from a variety of sources and processing that data to narrow down user options. In some cases, the cognitive radio may actually make decisions on its own without a user being involved.

Cognitive radio systems operate on many frequency bands using sharing spectrum principles. They efficiently and dynamically identify available spectrum to operate in. This could be accomplished by means consisting of sensing the environment, crosschecking with available databases containing information, such as existing transmitters in certain geographic areas and applying properly the operations rules of the network.

However, a cognitive radio may make improper decisions that cause it to fail to operate in areas where known licensed users exist and operate. For example, due to a variety of circumstances, a cognitive radio may operate at a frequency and a time that causes interference to other users.

### SUMMARY OF THE INVENTION

A method and apparatus for recovering from cognitive radio errors are disclosed. The method may include receiving stamp data relating to a cognitive radio from the cognitive radio's database, the stamp data including time, location and sensor information, comparing the received stamp data with information stored in a master database, determining, based on the comparison, whether the cognitive radio's database is corrupt, wherein if the cognitive radio's database is corrupt, downloading a copy of the master database to the cognitive radio.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary block diagram of cognitive radio network in accordance with a possible embodiment of the invention;

FIG. 2 illustrates an exemplary block diagram of a cognitive radio error recovery unit in accordance with a possible embodiment of the invention;

FIG. 3 is an exemplary flowchart illustrating one possible cognitive radio error recovery process in accordance with one possible embodiment of the invention; and

FIG. 4 is an exemplary flowchart illustrating another possible cognitive radio error recovery process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method and apparatus, and other embodiments that relate to the basic concepts of the invention. In particular, the invention concerns, among other things, a method and apparatus that would capture those cognitive radio events of incorrect decisions or errors, find those errors, and correct them. The capture of this error data may be made simply by monitoring the behavior of a user.

As an example, one of the reasons that errors situation could arise could be that the database of the cognitive radio may be corrupt. Another one example where an error may arise is the cognitive radio's sensors may be faulty. Yet another example where an error may arise may be that the transmission of the data from the network to the cognitive radio had suffered enough disturbances or interference that is the resulting data was corrupted.

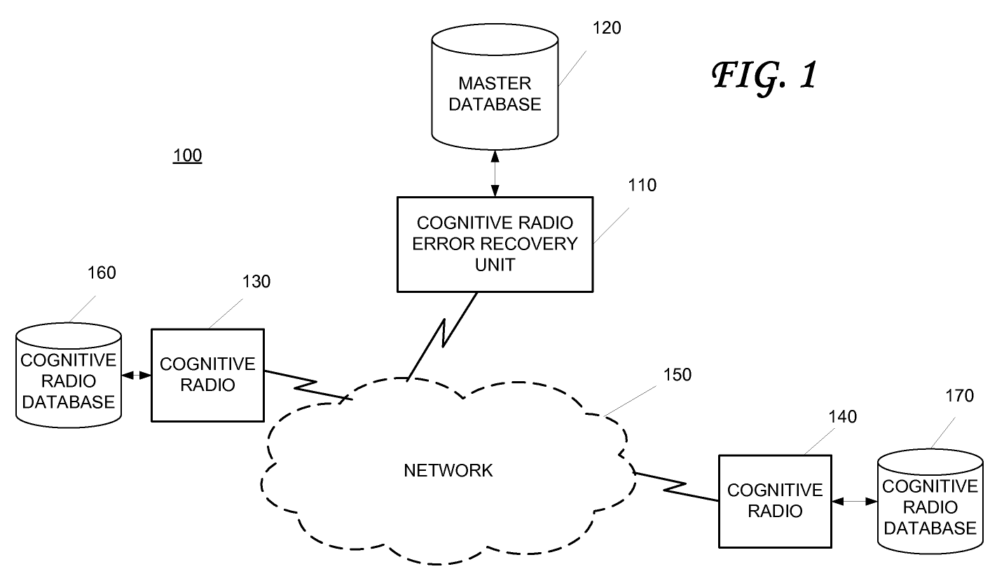

FIG. 1 illustrates a diagram of an exemplary cognitive radio network 100 in accordance with a possible embodiment of the invention. In particular, the exemplary cognitive radio network 100 includes cognitive radio recovery unit 110 and cognitive radios 130, 140 connected through network 150. The cognitive radio recovery unit 110 is coupled to, or includes, master database 120. Each of the cognitive radios 130, 140 has is own cognitive radio database 160, 170, respectively.

Network 150 may represent any communication network, including a cellular telephone network, mobile telephone network, Internet, intranet, or any other network known to one of skill in the art. Although only two cognitive radios are shown, one of skill in the art would appreciate that blocks are representative of many cognitive radios connected through the network 150.

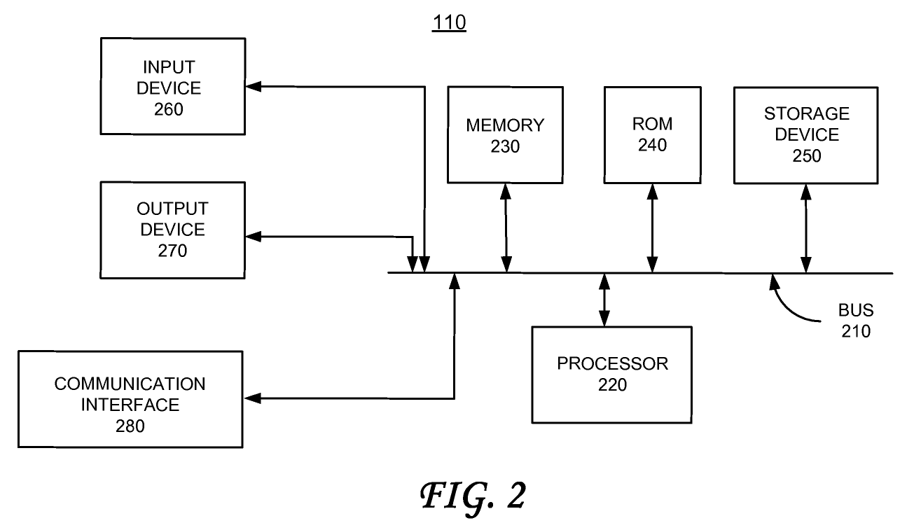

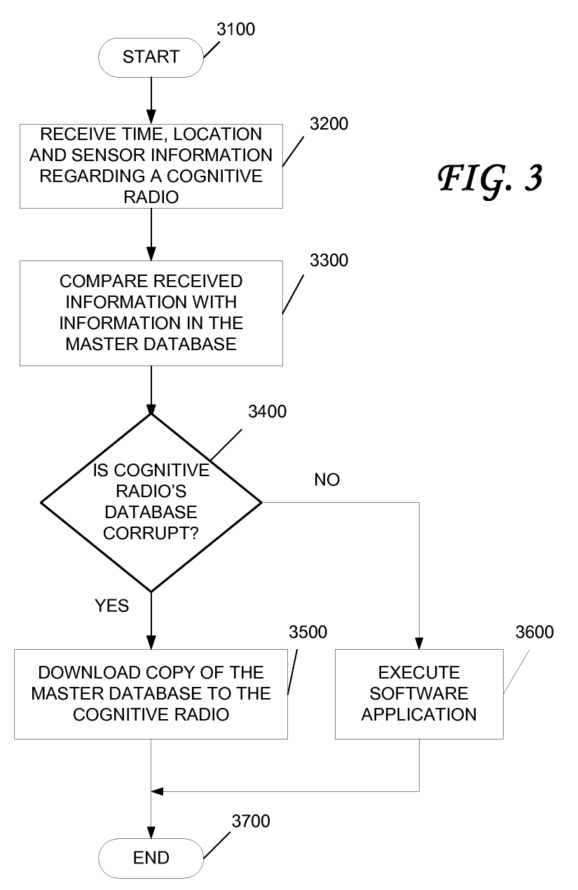

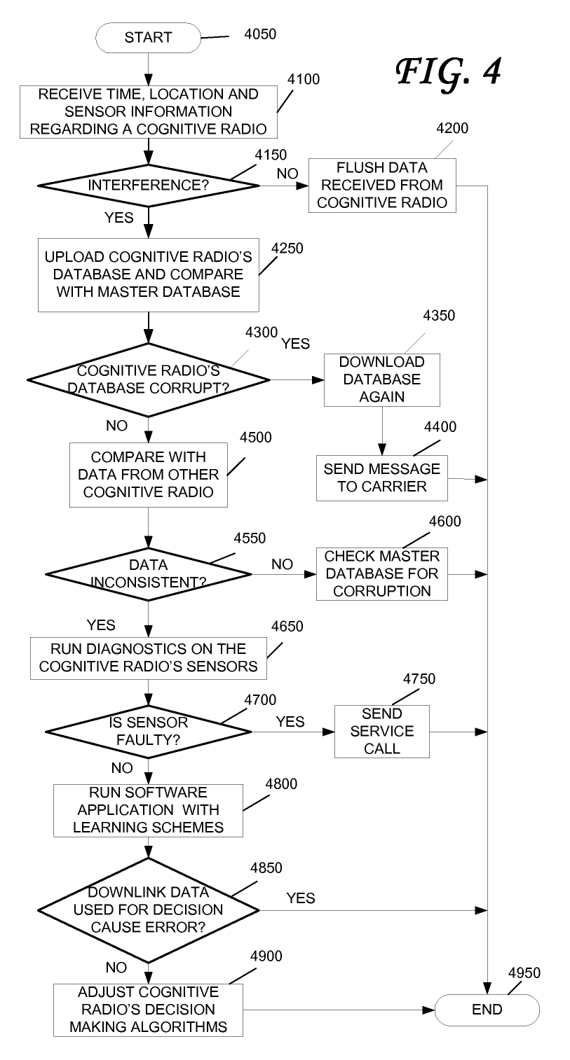

FIG. 2 illustrates an exemplary cognitive radio error recovery unit 110, or device which may implement one or more modules or functions of the cognitive radio error recovery process shown below in FIGS. 3 and 4. Thus, the exemplary cognitive radio error recovery unit 110 may include a bus 210, a processor 220, a memory 230, a read only memory (ROM) 240, a storage device 250, an input device 260, an output device 270, and a communication interface 280. Bus 210 may permit communication among the components of the cognitive radio error recovery unit 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to the cognitive radio error recovery unit 110, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the cognitive radio error recovery unit 110 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections. In some implementations of the cognitive radio system 100, communication interface 280 may not be included in the exemplary cognitive radio error recovery unit 110 when the cognitive radio error recovery process is implemented completely within the cognitive radio network 100.

The cognitive radio error recovery unit 110 may perform such functions in response to processor 220 by executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

The cognitive radio system 100 and the cognitive radio error recovery unit 110 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the cognitive radio error recovery unit 110, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

For illustrative purposes, the cognitive radio error recovery process will be described below in relation to the block diagrams shown in FIGS. 1 and 2.

FIG. 3 is an exemplary flowchart illustrating some of the possible steps associated with a cognitive radio error recovery process in accordance with a possible embodiment of the invention. The process begins at step 3100 and continues to step 3200 where the cognitive radio error recovery unit 110 receives stamp data, such as time, location and sensor information concerning a particular cognitive radio 130, 140. At step 3300, the cognitive radio error recovery unit 110 compares the received stamp data with corresponding data stored in the master database 120.

At step 3400, the cognitive radio error recovery unit 110 determines whether the cognitive radio's database 160, 170 has been corrupted. If the cognitive radio error recovery unit 110 determines that the cognitive radio's database 160, 170 has not been corrupted, at step 3600, the cognitive radio error recovery unit 110 executes the software application originally requested by the user. The process then goes to step 3700 and ends.

If the cognitive radio error recovery unit 110 determines that the cognitive radio's database 160, 170 has been corrupted, at step 3500, the cognitive radio error recovery unit 110 downloads a copy of the master database 120 to the affected cognitive radio 130, 140. The process then goes to step 3700 and ends.

FIG. 4 is an exemplary flowchart illustrating some of the possible steps associated with another cognitive radio error recovery process in accordance with another possible embodiment of the invention. The process begins at step 4050 and continues to step 4100 where the cognitive radio error recovery unit 110 receives stamp data, such as time, location and sensor information concerning a particular cognitive radio 130, 140. At step 4150, the cognitive radio error recovery unit 110 determines whether any interference exists. If no interference exists, then in step 4200, the cognitive radio error recover unit 110 flushes the data received from the cognitive radio 130, 140. This process may be performed after a delay time period. The process then goes to step 4950 and ends.

If the cognitive radio error recovery unit 110 determines that an interference exists, then at step 4250, the cognitive radio error recovery unit 110 uploads the affected cognitive radio's database 160, 170 and compares that database with the master database 120. At step 4300, the cognitive radio error recovery unit 110 determines whether the cognitive radio's database 160, 170 has been corrupted. If the cognitive radio's database 160, 170 has been corrupted, at step 4350, the cognitive radio error recovery unit 110 downloads the cognitive radio's database 160, 170 and compares it with the master database.

At step 4400, the cognitive error recovery unit 110 sends a message to the carrier to give notice that there was a disturbance in the network 150. The carrier may then determine the impact the interference and decide whether it should notify various other subscribers that may have been affected. The process then goes to step 4950, and ends.

If the cognitive radio error recovery unit 110 determines that the cognitive radio's database 160, 170 has not been corrupted, then at step 4500, the cognitive radio error recovery unit 110 compares the cognitive radio's database 160 with another cognitive radio database 170, for example. This comparison may be performed by running a diagnostic application, for example. One of skill in the art may appreciate that the diagnostic application may be any software/firmware application that performs the function of diagnosing a problem in equipment and/or network software or hardware.

At step 4550, the cognitive radio error recovery unit 110 determines if the cognitive radio databases 160, 170 are inconsistent. If the cognitive radio error recovery unit 110 determines that cognitive radio databases 160, 170 are not inconsistent, at step 4600, the cognitive radio error recovery unit 110 will store at least one of the cognitive radio databases 160, 170 and may further investigate the potential corruption of the master database 120. The process then goes to step 4950 and ends.

If the cognitive radio error recovery unit 110 determines that cognitive radio databases 160, 170 are inconsistent, at step 4650, the cognitive radio error recovery unit 110 runs diagnostics on the cognitive radio's sensors. At step 4700, the cognitive radio error recovery unit 110 determines whether one or more of the cognitive radio's sensors are faulty. If the cognitive radio error recovery unit 110 determines that one of the cognitive radios' sensors are faulty, at step 4750, the cognitive radio error recovery unit 110 sends for a service call. The process then goes to step 4950 and ends.

If the cognitive radio error recovery unit 110 determines that one of the sensors is not faulty, the cognitive radio error recovery unit 110 runs a software application with learning schemes. The cognitive error recovery unit 110 uses the learning schemes to try to learn from the patterns that it has observed. At step 4850, the cognitive radio error recovery unit 110 determines whether the downlink data used by the cognitive radio 130, 140 caused the error.

If the cognitive radio recovery unit 110 determines that the downlink data caused the error, the process goes to step 4950, and ends. If the cognitive radio error recovery unit 110 determines that the downlink data used by the cognitive radio 130, 140 did not cause the error, then at step 4900, the cognitive radio error recovery unit 110 adjusts the cognitive radio's decision making algorithm. The process then goes to step 4950, and ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the cognitive radio error recovery unit 110 in FIGS. 1 and 2 each processing the content in various possible ways. It does not necessarily need to be one system used by all end users. Accordingly, the appended claims and their legal equivalents should only define the invention, rather than any specific examples given.

We claim:

1. A method for recovery from cognitive radio errors, comprising:
receiving stamp data relating to a cognitive radio from the cognitive radio's database, the stamp data including time, location and sensor information;
comparing the received stamp data with information stored in a master database;
determining, based on the comparison, whether the cognitive radio's database is corrupt, wherein if the cognitive radio's database is corrupt,
downloading a copy of the master database to the cognitive radio.

2. The method of claim 1, further comprising:
determining if interference exists, wherein if interference exists,
uploading the cognitive radio's database; and
comparing the cognitive radio's database with the master database.

3. The method of claim 1, further comprising:
sending a message to the cognitive radio's carrier.

4. The method of claim 1, further comprising:
receiving stamp data from one or more other cognitive radios;
comparing the cognitive radio's stamp data with stamp data received from the one or more other cognitive radios; and
determining if the cognitive radio's stamp data is consistent with stamp data received from the one or more other cognitive radios.

5. The method of claim 4, wherein if the cognitive radio's stamp data is consistent with stamp data received from the one or more other cognitive radios, further comprising:
determining if the master database is corrupt.

6. The method of claim 1, further comprising:
determining if one of the cognitive radio's sensors is faulty.

7. The method of claim 6, wherein if one of the cognitive radio's sensors is determined to be faulty, further comprising:
sending a signal to initiate a service call.

8. The method of claim 1, further comprising:
determining whether downlink data caused the cognitive radio to make a decision error.

9. The method of claim 8, wherein if it is determined that the downlink data did not cause the cognitive radio to make a decision error, further comprising:
adjusting the cognitive radio's decision making process.

10. An apparatus, comprising:
a master database; and
a cognitive radio error recovery unit that receives stamp data relating to a cognitive radio from the cognitive radio's database, the stamp data including time, location and sensor information, compares the received stamp data with information stored in a master database, determines, based on the comparison, whether the cognitive radio's database is corrupt, wherein if the cognitive radio's database is corrupt, the cognitive radio error recovery unit downloads a copy of the master database to the cognitive radio.

11. The apparatus of claim 10, wherein the cognitive radio error recovery unit determines if interference exists, and if interference exists, the cognitive radio error recovery unit uploads the cognitive radio's database and compares the cognitive radio's database with the master database.

12. The apparatus of claim 10, wherein the cognitive radio error recovery unit sends a message to the cognitive radio's carrier.

13. The apparatus of claim 10, wherein the cognitive radio error recovery unit receives stamp data from one or more other cognitive radios, compares the cognitive radio's stamp data with stamp data received from one or more other cognitive radios, and determines if the cognitive radio's stamp data is consistent with stamp data received from the one or more other cognitive radios.

14. The apparatus of claim 13, wherein if the cognitive radio error recovery unit determines that the cognitive radio's stamp data is consistent with stamp data received from the one or more other cognitive radios, the cognitive radio error recovery unit determines if the master database is corrupt.

15. The apparatus of claim 10, wherein the cognitive radio error recovery unit determines if one of the cognitive radio's sensors is faulty.

16. The apparatus of claim 15, wherein if the cognitive radio error recovery unit determines that one of the cognitive radio's sensors is faulty, the cognitive radio error recovery unit sends a signal to initiate a service call

17. The apparatus of claim 10, wherein the cognitive radio error recovery unit determines whether downlink data caused the cognitive radio to make a decision error.

18. The apparatus of claim 17, wherein if the cognitive radio error recovery unit determines that the downlink data did not cause the cognitive radio to make a decision error, the cognitive radio error recovery unit adjusts the cognitive radio's decision making process.

19. The apparatus of claim 10, wherein the apparatus is connected to a cognitive radio network.

20. A method for recovery from cognitive radio errors, comprising:
receiving stamp data relating to a cognitive radio from the cognitive radio's database, the stamp data including time, location and sensor information;
determining if interference exists, wherein if interference exists,
uploading the cognitive radio's database;
comparing the received stamp data with information stored in a master database;
determining, based on the comparison, whether the cognitive radio's database is corrupt, wherein if the cognitive radio's database is determined to be corrupt, downloading a copy of the cognitive radio's database and sending a message to the cognitive radio's carrier;
receiving stamp data from one or more other cognitive radios;
comparing the cognitive radio's stamp data with stamp data received from one or more other cognitive radios;
determining if the cognitive radio's stamp data is consistent with stamp data received from the one or more other cognitive radios, wherein if the cognitive radio's stamp data is consistent with stamp data received from the one or more other cognitive radios, determining if the master database is corrupt;
determining if one of the cognitive radio's sensors is faulty, wherein if one of the cognitive radio's sensors is faulty, sending a signal to initiate a service call;
determining whether downlink data caused the cognitive radio to make a decision error, wherein if it is determined that the downlink data did not cause the cognitive radio to make a decision error,
adjusting the cognitive radio's decision making process.
